(19) United States
(12) Patent Application Publication
(10) Pub. No.: US 2015/0059229 A1
(43) Pub. Date: Mar. 5, 2015

(54) Waterfowl Decoy with Interchangeable Multifunction Feature Keels

(71) Applicant: Michael D. Miller, Donalsonville, GA (US)

(72) Inventor: Michael D. Miller, Donalsonville, GA (US)

(21) Appl. No.: 14/016,065

(22) Filed: Aug. 31, 2013

(51) Int. Cl. A01M 31/06

(52) U.S. Cl. CPC A01M 31/06
USPC 43/3; 29/428

(57) ABSTRACT

The present invention relates to floating waterfowl decoys featuring a multiplicity of interchangeable multifunction feature keels that allow the user to equip the decoy with various animating, affixing, and retrieving systems.

### CROSS-REFERENCE TO RELATED APPLICATIONS

Not applicable.

### FIELD OF THE INVENTION

The present invention relates to floating waterfowl decoys in general and to a type of floating duck decoy featuring a multiplicity of interchangeable multifunction feature keels that allow the user to equip the decoy with various animating, affixing, and retrieving systems, in particular.

### BACKGROUND OF THE INVENTION

Duck decoys are well known fodder for patentable innovations. Decoys with anchors, retractable tethering lines, motors and propellers, bubblers, wake simulators, and the like are well known. Decoys that maneuver in tandem with other decoys, whether independently or externally animated and guided, are well known to sportsmen. Of those that are independently animated and guided, some are constructed such that the functional elements are inside the body of the decoy (e.g. U.S. Pat. No. 8,276,308—Semiautonomous Waterfowl Decoy System). Some are constructed such that the functional elements are installed in a keel or housing affixed to the base of the decoy (e.g. U.S. Pat. No. 7,975,421—Remote Control Decoy). The latter type is generally preferable because it adds to the operational stability of the decoy in wind-blown ponds and moving streams. A few duck decoys are equipped with a means of interchanging keels (e.g. U.S. Pat. No. 6,647,657—Adjustable Duck Decoy), however these interchangeable keels perform the same or similar functions as the ones they replace. For example, interchangeable keels of varying weights may be used in varying depths of water. Similarly, weighted keels may be available in different forms: lead weighted or water weighted—the latter being lighter to pack to a distant hunting spot. The main disadvantage of these devices is that if a user wants the decoy to perform another set of functions, the user must purchase another decoy. For example, if the user wants a decoy with a retractable tether and anchor, or wants a decoy that blows bubbles from the base, or wants a decoy that simulates diving to feed, or wants a decoy that autonomously travels to and fro on the surface of the water, the user must buy a new decoy. This is clearly wasteful and inefficient. What is needed then is a decoy with interchangeable keels, wherein each keel performs at least two distinct functions: 1) Adjustably weighting and thus stabilizing the decoy in the water; and, 2) At least one other animating, affixing, or retrieving function.

### BRIEF SUMMARY OF THE INVENTION

Generally, the present invention provides a waterfowl decoy molded or otherwise formed from a plastic, such as polyethylene, or wood, such as cork. The decoy is air-tight, either intrinsically because the material from which it is made comprises a multiplicity of air filled cavities, or the decoy is molded with air trapped inside one or more cavities. The decoy is painted in the usual manner to represent a particular type of waterfowl. The base of the decoy is generally flat and contains locking holes through which locking tabs extending from the top surface of the keel pass to secure the keel to the bottom of the decoy. The base of the decoy may contain other perforations accommodating accessory devices extending above the top surface of the keel. By this means, an accessory device may be included in the keel that is vertically larger than the keel itself.

In a first embodiment, the keel is elongate, generally rectangular in transverse cross section, hollow, and molded of plastic such as polyethylene. At least part of the hollow interior of the keel is segregated from the rest of the interior of the keel and is externally accessible by means of a port with a cap and may be filled with various weighting substances such as lead shot, sand, or water. At least part of the balance of the hollow interior of the keel is segregated from the capped space and contains a spring-loaded rotary cord retracting system comprising a spool containing a suitable length of anchoring cord wherein the anchoring cord is affixed at one end to the central axis of the spool and at the other end to a suitable anchoring device such as a hook or a flat bar weight. A coiled spring is affixed to the spool such that as the anchoring cord is extended, the spring is wound progressively more tightly. Molded around the periphery of the spool, or otherwise formed as a part of it, is a ratchet wheel. The ratchet wheel interoperates with a release pawl such that as the anchoring cord is extended and the spring is wound progressively more tightly, the release pawl blocks the teeth of the ratchet wheel such that the spring is prevented from winding the anchoring cord back onto the spool. By this means the user can extend the anchoring cord to any desired length and the anchoring cord will remain deployed at this length. The release pawl is attached to a release slide such that when the release slide is manually actuated, the release pawl is withdrawn from the teeth of the ratchet wheel, the spring is allowed to unwind, and the anchoring cord is wound onto the spool.

This embodiment is used in the following manner: First, the user selects a suitable decoy to attract the type of waterfowl desired. Next, the user affixes the keel to the bottom of the decoy such that the locking tabs of the keel pass through and lock into the locking holes of the decoy. Next, the user deploys the anchoring cord to the desired length. Next the user places the decoy in the water letting the anchoring cord drop so that the hook or flat bar weight at the distal end secures the decoy in substantially the same position on the surface of the water. After use, the user retrieves the decoy and manually operates the release slide such that the release pawl is withdrawn from the teeth of the ratchet wheel, the spring uncoils, and the anchoring cord is wound onto the spool. Finally, the user removes the keel by releasing the locking tabs from the locking holes, thus readying the keel for attachment to a different decoy.

### BRIEF DESCRIPTION OF THE DRAWINGS

FIG. 1 is a bottom plan view showing a decoy of the present invention.

FIG. 2 is a bottom plan view showing a decoy of the present invention with one embodiment of a multifunction feature keel design to allow the user to adjustably weight and stabilize the decoy and deploy and retract the anchoring line into the keel.

FIG. 3 is a side elevation with a partial cross-section showing a decoy with one embodiment of a multifunction feature keel design to allow the user to adjustably weight and stabilize the decoy and deploy and retract the anchoring cord into the keel with the slide lock moved rearward in the unlocked position.

FIG. 4 is a side elevation with a partial cross-section showing a decoy with one embodiment of a multifunction feature keel design to allow the user to adjustably weight and stabilize the decoy and deploy and retract the anchoring cord into the keel with the slide lock moved forward in the locked position.

FIG. 5 is a front elevation with a partial cross-section showing a decoy with one embodiment of a multifunction feature keel design to allow the user to adjustably weight and stabilize the decoy and deploy and retract the anchoring cord into the keel.

### DETAILED DESCRIPTION OF THE INVENTION

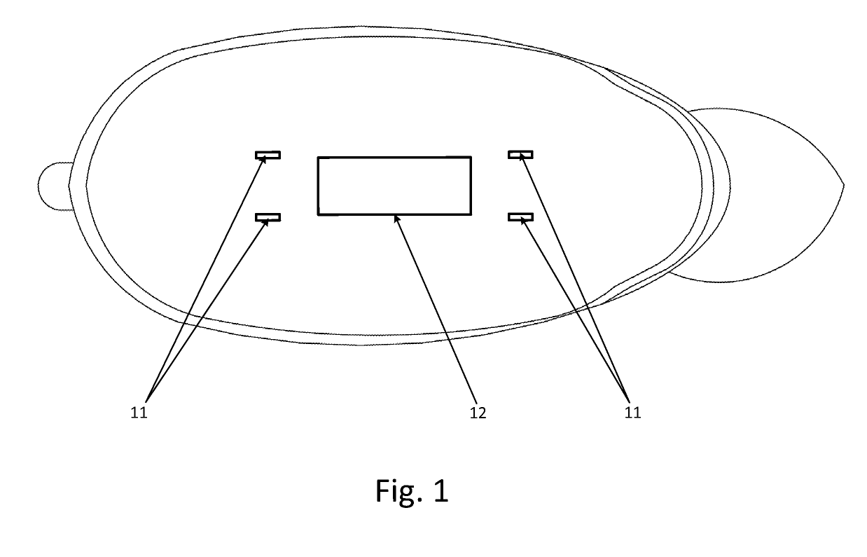

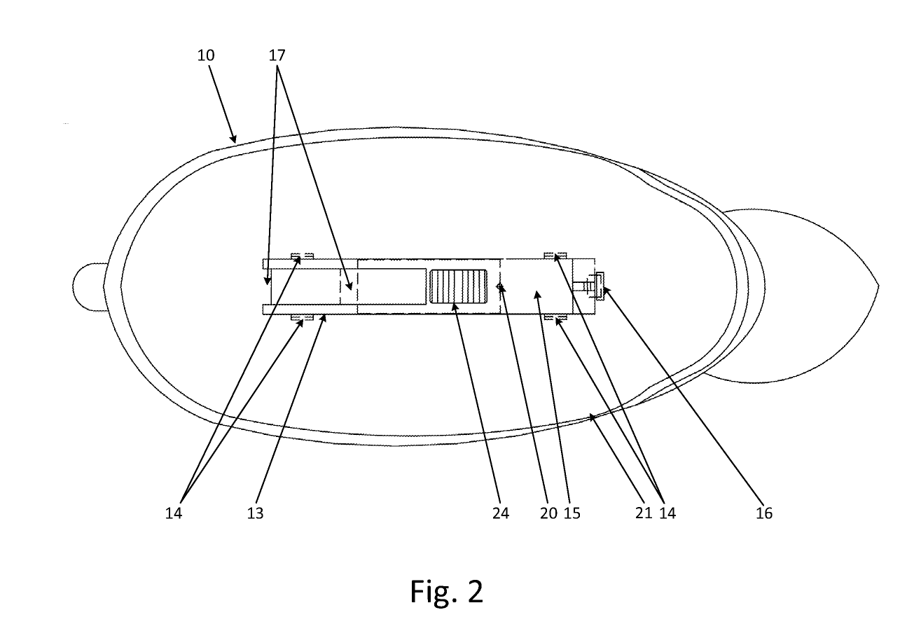

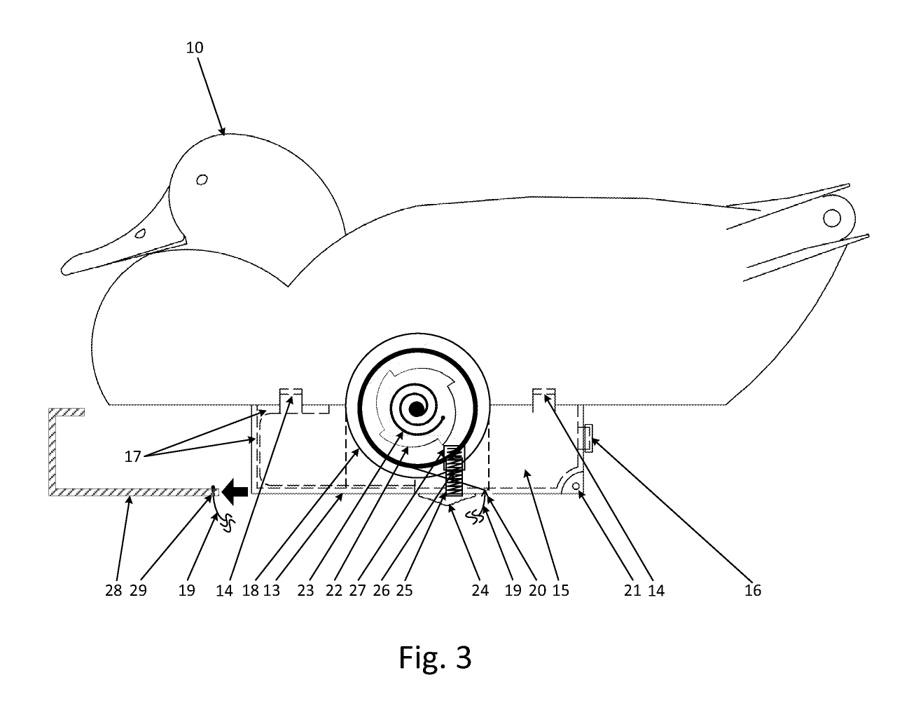

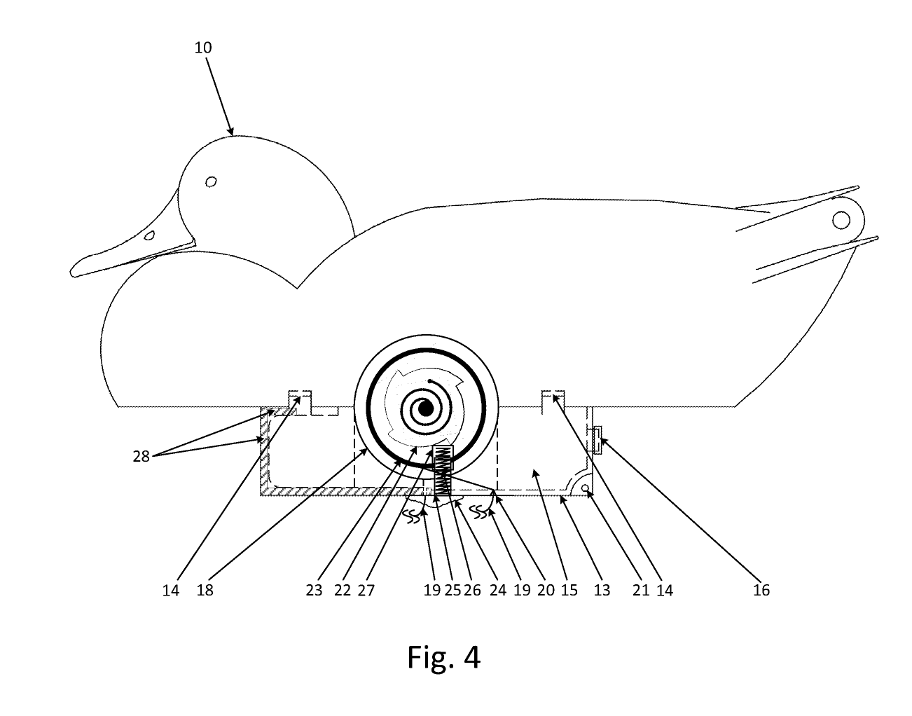

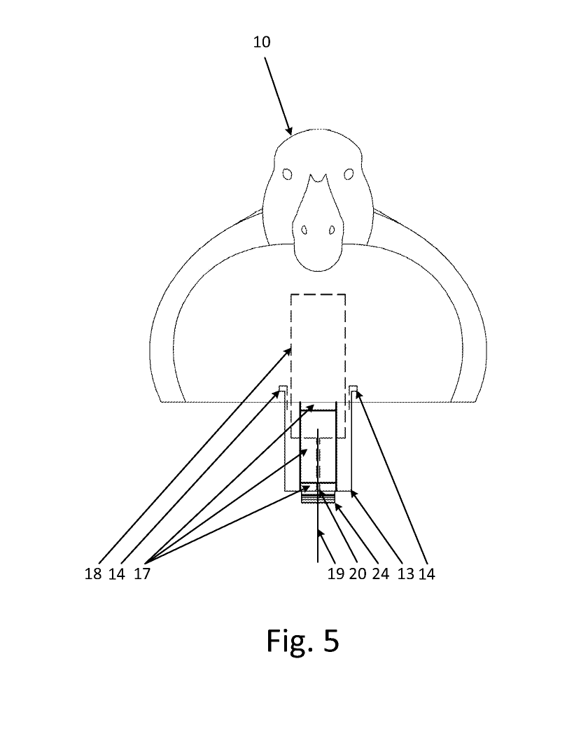

Turning now to FIGS. 1 through 5 the present invention provides a waterfowl decoy 10 molded or otherwise formed from a plastic, such as polyethylene or expandable polymeric beads, or wood, such as cork. Decoy 10 is air-tight, either intrinsically because the material from which it is made comprises a multiplicity of air filled cavities, or it is molded with air trapped inside larger closed cavities. Decoy 10 is painted in the usual manner to represent a particular type of waterfowl and may be decorated with feathers, jewels, and other materials to enhance the realism of the decoy. The base of decoy 10 is generally flat and contains locking holes 11 through which locking tabs 14 extending from the top surface of keel 13 pass to secure keel 13 to the bottom of decoy 10. In this embodiment of the invention, locking tabs 14 are flexible plastic each with an outwardly projecting retaining tang such that the user slightly compresses each pair of locking tabs 14 to introduce them into locking holes 11. When each locking tab 14 is fully inserted into its respective locking hole 11 each respective locking tab 14 expands to its original uncompressed configuration and simultaneously insinuates its projecting retaining tang inside an associated mating slot provided in the interior of decoy 10. To release keel 13, the user slightly compresses each pair of locking tabs 14 to release the retaining tangs from decoy 10 and withdraws keel 13 from decoy 10. Ordinarily, the base of decoy 10 will contain other perforations 12 accommodating various accessory devices extending above the top surface of keel 13. By this means, accessory devices may be included in keel 13 that are vertically larger than keel 13. For example, in this exemplary embodiment perforation 12 passes through the molded outer shell of decoy 10 and, as a result, spool 18 projecting above keel 13 extends up into the hollow interior of decoy 10 when keel 13 is affixed to decoy 10.

In this exemplary embodiment, keel 13 is elongate, generally rectangular in transverse cross section, hollow and molded of plastic such as polyethylene. At least part of the hollow interior of keel 13 is segregated from the rest of the interior of keel 13 into a closed ballast chamber 15 that is externally accessible by means of cap 16. Ballast chamber 15 may be filled with various weighting materials such as lead shot, sand, or water. While cap 16 may be sealed at the time of manufacture, it will be obvious that cap 16 may be removable, thus allowing the user to select the type and amount of ballast material placed inside keel 13. At least part of the balance of the hollow interior of keel 13 is segregated from ballast chamber 15 and contains a spring-loaded rotary cord retracting system comprising spool 18 containing a suitable length of anchoring cord 19 wherein anchoring cord 19 is affixed at one end to the central axis of spool 18. After passing from the hollow interior of keel 13 to the outside via port 20, the other end anchoring cord 19 is tied to a suitable anchoring device such as a hook or flat bar weight 28. Molded around the periphery of spool 18, or otherwise formed as a part of it, is ratchet wheel 22. Coil spring 23 is affixed to ratchet wheel 22 and wound around the central axis of spool 18 such that as anchoring cord 19 is extended coil spring 23 is wound progressively more tightly. Slide release 24 is attached to a release pawl comprised of base 25 and catch 27 slidably displaceable with respect to one another with spring 26 interposed inside both such that catch 27 is ordinarily displaced upwards so that the release pawl is at its maximum length. When slide release 24 is pushed forward, the release pawl is also moved forward such that catch 27 interoperates with ratchet wheel 22 so that anchoring cord 19 may be pulled from spool 18 and progressively tighten coil spring 23 while preventing it from winding anchoring cord 19 back onto spool 18. By this means, the user can extend anchoring cord 19 to any desired length. To release catch 27, the user pushes slide release 24 towards the back. This simultaneously moves catch 27 towards the back such that it no longer interoperates with ratchet wheel 22. By this means coil spring 23 is freed to rewind spool 18 thus simultaneously rewinding anchoring cord 19 back onto spool 18. If a hook is affixed to the distal end of anchoring cord 19 it may be stowed to keel 13 by passing one of its tines through hole 21. Ordinarily, flat bar weight 28 is in the form of a thin flat bar bent into a substantially “J” shaped hook and perforated by hole 29. Flat bar weight 28 is tied to distal end of anchoring cord 19 by means of passing anchoring cord 19 through hole 29 and knotting it, such that when anchoring cord 19 is fully wound back onto spool 18, flat bar weight 28 may be stowed into weight retaining slot 17 formed in the top, front, and bottom surfaces of keel 13. When stowed in this manner, flat bar weight 28 is held in place by means of slide release 24 when pushed forward. This secures flat bar weight 28 to keel 13 and prevents it from marring other decoys in a storage bag or box.

Those having skill in the art will recognize that numerous alternative means of extending a cord from a spool and fixing the cord at a desired length while allowing for the subsequent automatic retraction of the cord back onto the spool are well known in the prior art. All such equivalent formulations and designs are included in the spirit and scope of the present invention. Similarly, those having skill in the art will recognize that numerous alternative means of affixing keel 13 to decoy 10 are well known in the prior art. In the exemplary embodiment, locking tabs 14 interoperate with locking holes 11 in the base of decoy 10 to accomplish this task, but other methods such as hook and ball or loop (Velcro®) fasteners, various types of screws, latches, hooks, cam lock fasteners, and magnets may be used. As above, all such equivalent formulations and designs are included in the spirit and scope of the present invention.

The exemplary embodiment of the invention is used in the following manner: First, the user selects a suitable decoy 10 to attract the particular type of waterfowl desired. Next, the user affixes keel 13 to the bottom of decoy 10 such that locking tabs 14 of keel 13 pass through and lock into locking holes 11 in the base of decoy 10. In this exemplary embodiment of the invention, spool 18 passes through perforation 12 into the hollow cavity of decoy 10. Since anchoring cord 19 exits from keel 13 closer to one end of keel 13 than the other, there is a natural tendency for an attached decoy 10 to move in the direction of the prevailing current or wind when decoy 10 is deployed in water. Therefore, the user may wish to configure some decoys 10 so that anchoring cord 19 exits from keel 13 closer to the head of decoy 10 and some decoys 10 so that anchoring cord 19 exits from keel 13 closer to the tail of decoy 10. By this means, some decoys will appear oriented in one direction while the rest will appear oriented in the opposite direction without regard to the direction of the prevailing current or wind. This allows the user to create a more natural appearing group of decoys on the surface of the water. Next, the user pushes slide release 24 forward thus interposing catch 27 into the teeth of ratchet wheel 22. Next, the user deploys anchoring cord 19 to the desired length and places decoy 10 in the water letting anchoring cord 19 drop such that the hook or flat bar weight 28 at its distal end secures the decoy in substantially the same position on the surface of the water. After use, the user retrieves decoy 10 and pushes slide release 24 to the rear. This moves catch 27 towards the rear such that it no longer interoperates with ratchet wheel 22. By this means coil spring 23 is freed to rewind spool 18 thus simultaneously rewinding anchoring cord 19 back onto spool 18. If a hook was attached to the distal end of anchoring cord 19, it may be secured to keel 13 by means of passing one of its tines through hole 21. If flat bar weight 28 was attached to the end of anchoring cord 19, it may be secured to keel 13 by sliding it into weight retaining slot 17 while simultaneously pressing slide release 24 forward to lock flat bar weight 28 into weight retaining slot 17. Finally, the user removes keel 13 by releasing locking tabs 14 from locking holes 11, thus allowing keel 13 to be removed from decoy 10 and readying it for attachment to a different decoy.

It will be readily evident to those having skill in the art that the exemplary embodiment of the invention is not the only embodiment that may be conceived. For example, it will be readily apparent that a variant of the invention in which keel 13 contains a battery, an electric air pump, and a means selectively supplying electric current to the air pump may be used to generate a stream of bubbles surrounding the base of decoy 10 when it is in the water. Similarly, it will be readily apparent that a variant of the invention in which keel 13 contains a battery, a sound generator, and a means selectively supplying electric current to the sound generator may be used such that decoy 10 continuously or intermittently generates the sound of a particular kind of waterfowl. Similarly, it will be readily apparent that a variant of the invention in which keel 13 contains a battery, an electric motor, a means of reducing the speed of the electric motor, such as a gear train, with its output shaft coupled to simulated feet extending laterally from keel 13, and a means selectively supplying electric current to the electric motor may be used such that decoy 10 simulates paddling. Similarly, it will be readily apparent that a variant of the invention in which the keel 13 contains a battery, an electric motor with attached propeller, a servo control with attached rudder, and a remote control receiver to control the angle of the rudder and the speed of the electric motor may be used to propel an attached decoy 10 remotely by means of a remote control transmitter. Similarly, it will be readily apparent that a variant of the invention in which keel 13 contains a battery, a fluid pump, a reversible electric valve, an internal ballast chamber fluidically coupled to the fluid pump and the valve, and a means of selectively supplying electric current to the fluid pump and alternating the state of the valve may be used to cause to forward aspect the decoy 10 to submerge and subsequently refloat to simulate feeding. Further, in these alternative variants all or some of the functional characteristics of the exemplary embodiment may be included in keel 13 while some may be absent.

What is claimed is:

1. A waterfowl decoy system comprising:
a) a waterfowl decoy having at least one inner cavity within;
b) a removable keel having at least a first and second cavity within wherein said first cavity has an access port that may be filled with ballast material and capped and said second cavity at least partially contains a spring actuated spool for deploying and collecting an anchoring cord with an anchoring device affixed at its distal end.

2. A waterfowl decoy system of claim 1 such that said second cavity is a substantially watertight compartment.

3. A waterfowl decoy system of claim 1 such that when said removable keel is affixed to said waterfowl decoy said spring actuated spool extends into the inner cavity of said waterfowl decoy.

4. A waterfowl decoy system of claim 1 such that said anchoring device is a hook.

5. A waterfowl decoy system of claim 1 such that said anchoring device is a flat bar weight.

6. A waterfowl decoy system of claim 5 such that said flat bar weight may be secured to said removable keel.

7. A method of manufacturing a waterfowl decoy system comprising the steps of:
a) providing a waterfowl decoy body having at least one inner cavity within;
b) providing a removable keel having at least a first and second cavity within; and
c) mounting a spring actuated spool for deploying and collecting an anchoring cord at least partially in said second cavity and affixing an anchoring device at the distal end of said anchoring cord.

8. A method of manufacturing a waterfowl decoy system of claim 7 further comprising the step of placing a cap on said access port of said removable keel communicating with said first cavity.

9. A method of manufacturing a waterfowl decoy system of claim 7 further comprising the step of placing a ballast weight on said removable keel.

10. A method of using a waterfowl decoy system of claim 1 comprising the steps of:
a) selecting a suitable waterfowl decoy from a plurality of waterfowl decoys;
b) affixing a removable keel to said waterfowl decoy;
c) deploying the anchoring cord with anchoring device affixed at its distal end from said removable keel to a desired length;
d) placing said waterfowl decoy in the water such that said removable keel, said anchoring cord, and said anchoring device extend into the water and said anchoring device secures said waterfowl decoy in the water.
